(19) United States
(12) Patent Application Publication
(10) Pub. No.: US 2007/0125943 A1
(43) Pub. Date: Jun. 7, 2007

(54) HORN MASS SPECTROMETER HAVING BLADE DEFLECTORS

(76) Inventor: James G. Hagerman, Honolulu, HI (US)

Correspondence Address: LEIGHTON K. CHONG;PATENT ATTORNEY, 133 KAAI STREET, HONOLULU, HI, 96821, US

(21) Appl. No.: 11/536,632

(22) Filed: Sep. 28, 2006

Related U.S. Application Data
(63) Continuation-in-part of application No. 11/297,238, filed on Dec. 7, 2005.

(51) Int. Cl. H01J 49/42

(52) U.S. Cl. 250/292

(57) ABSTRACT

An improved design for a rotating electric field ion mass spectrometer has deflection electrodes formed as an array of blade elements arrayed radially and circumferentially about an ion axis of the mass spectrometer. The blade elements are formed as flat metal pieces having inner edges shaped in a hyperbolic curve. When a sufficient number of blades are aligned orthogonally to form a horn shape along an ion axis of a hyperbolic helical horn mass spectrometer, the resultant electric field approximates that of using hyperbolic wall surfaces for the deflection electrodes. The blade array design reduces the cost of fabrication, capacitive loading, and vacuum capacity as compared to using cylindrically symmetric, hyperbolic wall surfaces for the deflection electrodes.

This U.S. patent application is a continuation-in-part of co-pending U.S. patent application Ser. No. 11/297,238 of the same inventor filed on Dec. 7, 2005, entitled “Hyperbolic Horn Helical Mass Spectrometer”

### TECHNICAL FIELD

This invention generally relates to an improvement for a rotating electric field ion mass spectrometer (REFIMS), and more particularly, to one which reliably handles the ion input beam with better tolerance for entrance angle and sensitivity.

### BACKGROUND OF INVENTION

A prior type of rotating electric field ion mass spectrometer (REFIMS) has an analyzer cell with an entrance end, four spaced-apart longitudinal deflector walls to which time-dependent phased RF potentials are applied, and a detector at its target end. This type of REFIMS cell is described in U.S. Pat. No. 5,726,448 issued on Mar. 10, 1998, to S. J. Smith and A. Chutjian, which is incorporated by reference. The time-dependent RF potentials applied to the cell walls create an RF field which effectively rotates the ion beam within the cell. As the ions of the beam are rotated into a spiral path in the cell, the rotating RF field disperses the ion beam according to the mass-to-electrical charge (m/e) ratio and velocity distribution present in the ion beam. The ions of the beam are deflected angularly on the target detector, depending on the m/e, RF amplitude, and RF frequency. The detector counts the incident ions to determine the m/e and velocity distribution of ions in the beam, thereby providing a profile of the elemental constituents in the beam. One possible advantage of this type of device is that the spectral readout can be developed over a two-dimensional detector plane, which provides enhanced profile information for analysis as compared to the conventional one-dimensional (spot or line) spectral readouts. Further descriptions of this type of system are provided in: Clemmons, J. H., 1992, “Sounding rocket observations of precipitating ions in the morning auroral region”, Ph. D. dissertation, Univ. California, Berkeley, 135 pp; and Clemmons, J. H., and Herrero, F. A., 1998, “Mass spectroscopy using a rotating electric field”, Rev. Sci. Instruments 69, 2285-2291.

Unfortunately, the REFIMS device heretofore has had severe inherent problems relating to ion entrance angle and sensitivity that have made it practically unusable. The abrupt transition from free-space to the RF electric field between the grids requires that the ion entrance angle, offset, and timing coincide with the resonant helical path at an exact RF phase. Looked at in reverse, a resonant ion beam exiting the grids would travel out at a particular angle and offset radius, in contrast to the incident beam direction along the central longitudinal axis. Constructing a device with these limitations is possible, but the loss of sensitivity is remarkable. Only ions entering the chamber at the exact RF phase will resonate, all others are rejected, even if of the correct mass. If this tolerance is off by +/−1 degree, it means a sensitivity loss of 180 times, even before filtering takes place.

In my co-pending U.S. patent application Ser. No. 11/297,238, filed on Dec. 7, 2005, an improved rotating electric field ion mass spectrometer provides for a smooth transition for the input ion beam for the electric field strength in the cell by starting the field strength impact on the ion helical radius at zero and smoothly increasing it to the desired value for rotating the beam. This is accomplished by modifying the grid shape at the entrance from a fixed-diameter tunnel to that of a horn. Looking like the bell of a trumpet, the horn shape has a flare end with a larger entrance width that reduces the grid electric field strength to near zero and causes no abrupt deflection of the beam at the entrance, and tapers along the longitudinal z axis to a narrower width so that the field strength applied to the beam increases gradually until the correct angle, offset, and timing are obtained at its exit end for driving the beam into the desired rotation for the REFIMS device. Preferably, the horn shape in cross-section is hyperbolic, and the field strength increases linearly with distance along the z axis. My prior U.S. patent application Ser. No. 11/297,238 is incorporated by reference herein in its entirety.

In my prior application, the hyperbolic helical horn mass spectrometer (3HMS) has hyperbolic-shaped wall surfaces for the deflection electrodes. FIG. 1 shows a schematic of a 3HMS unit housed within a vacuum chamber, and FIG. 2 shows a perspective view of the 3HMS prototype showing the positioning of the horn-shaped deflection grids. Cylindrically symmetric, the sheet is split into an even number of wall sections and driven by sine and cosine waveforms. Mathematically this is very simple and produces a very well defined ion trajectory. However, fabrication of the assembly can prove to be costly, requiring precision 3-axis machining and polishing. Moreover, it also has drawbacks of high capacitive loading and poor vacuum capacity.

### SUMMARY OF INVENTION

In accordance with the present invention, a novel construction is provided for the deflection electrodes of a rotating electric field ion mass spectrometer, wherein the deflection electrodes are formed as an array of blade elements arrayed radially and circumferentially about the ion axis and extending along its longitudinal length. In particular, a hyperbolic helical horn mass spectrometer (3HMS) is formed with such an array of blade elements aligned in an orthogonal fashion to replicate the same shape of hyperbolic electrode surfaces. When a sufficient number of blades are used, the resultant electric field exhibits a nearly identical constitution as using hyperbolic wall surfaces for the deflection electrodes. The orthogonal blade design solves the problems of costly fabrication, high capacitive loading and poor vacuum capacity, as compared to using cylindrically symmetric, hyperbolic wall surfaces for the deflection electrodes.

### BRIEF DESCRIPTION OF DRAWINGS

FIG. 1 shows a schematic of a prior hyperbolic helical horn mass spectrometer (3HMS) having hyperbolic wall surfaces for the deflection electrodes.

FIG. 2 shows a perspective view of the prior 3HMS unit showing the positioning of the horn-shaped deflection wall surfaces.

FIG. 3 shows a schematic end-on view of the improved “blade” array of deflector elements for the 3HMS unit in accordance with the present invention.

FIG. 4 shows a side view of a pair of blade elements in one plane of the blade array.

FIG. 5 illustrates a 24-pole arrangement for the blade deflector elements of the 3HMS unit.

FIG. 6 illustrates the problem of field distortion in a simulation of a parallel plate capacitor made from spaced wires.

FIG. 7 illustrates a uniform field obtained when the distance between simulated electrode surfaces is much greater than the spacing between elements simulating those surfaces.

FIG. 8 shows a 24-blade deflector array generating a convex field shape.

FIG. 9 shows a 24-blade deflector array generating a concave field shape.

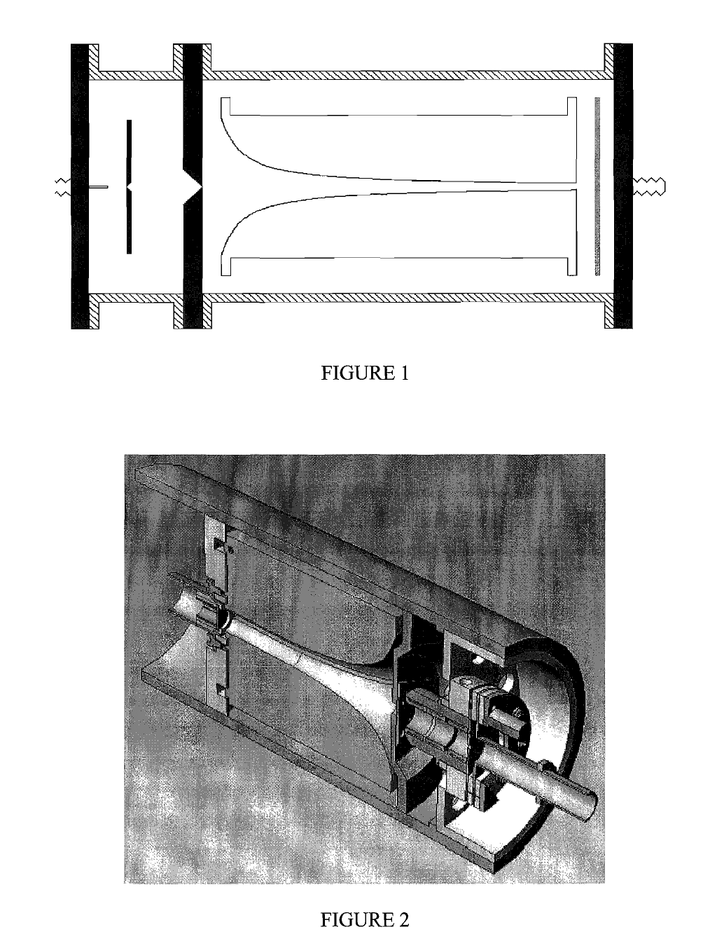

### DETAILED DESCRIPTION OF INVENTION

In the following detailed description of the invention, certain preferred embodiments are illustrated providing certain specific details of their implementation. However, it will be recognized by one skilled in the art that many other variations and modifications may be made given the disclosed principles of the invention.

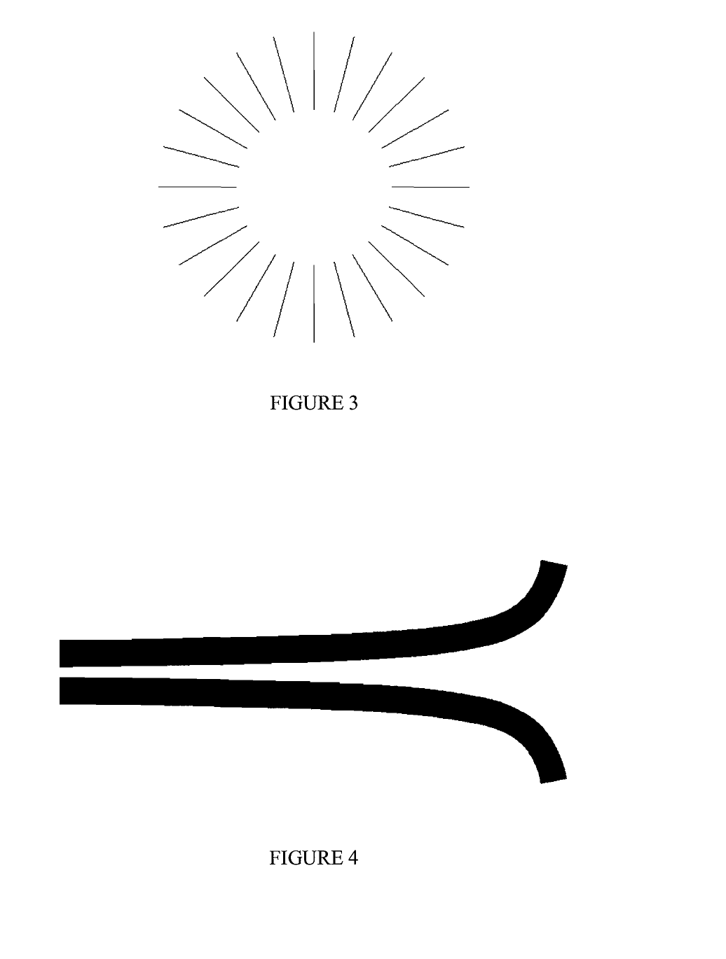

FIG. 3 shows a schematic end-on view of the improved “blade array” construction for the deflector electrodes of a hyperbolic helical horn mass spectrometer (3HMS) unit in accordance with the present invention. The blades are arrayed radially and circumferentially about the ion axis of the horn extending along its longitudinal length. If an infinite number of blades are used, the inner surfaces of the blade would form an exact replica of the hyperbolic wall surfaces of the prior design shown in FIG. 2. It is found in the present invention that use of a sufficient number of blade elements can provide an electric field similar to using an infinite number or using hyperbolic plane surfaces for the deflection electrodes, while still maintaining electric field integrity.

FIG. 4 shows a side view of a pair of blade elements in one plane of the blade array. The inner edges 40 of the blade elements follow the same hyperbolic curve specified for optimum 3HMS design parameters. The thickness and height of the blades may be varied depending on desired metal fabrication requirements. Fabrication costs can be greatly reduced, as each blade element can be easily stamped or cut from a sheet of metal stock with great accuracy. No other machining or polishing is necessary.

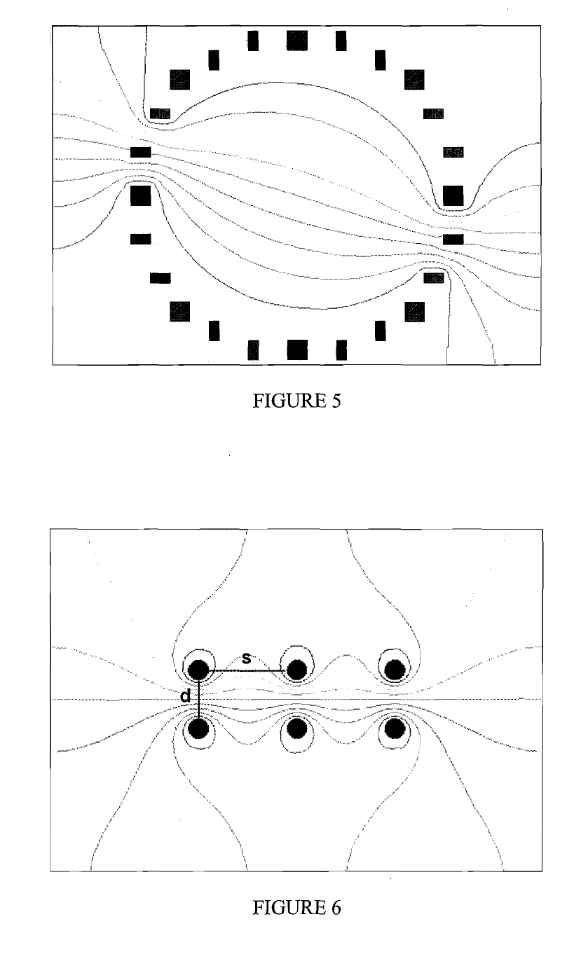

Field simulations of a 24-pole arrangement, as shown in FIG. 5, exhibit near-perfect field isopotential lines. Of significance is the linearity of the field near the center, where the ion trajectory is located. Resonant ions will remain within a given exit radius representing an equilibrium between the forces of deflection and inertia. For optimum field contours, it is important that the blades be relatively close together, such that the radius becomes a far field. Too few blades and the field distortions become considerable and problematic.

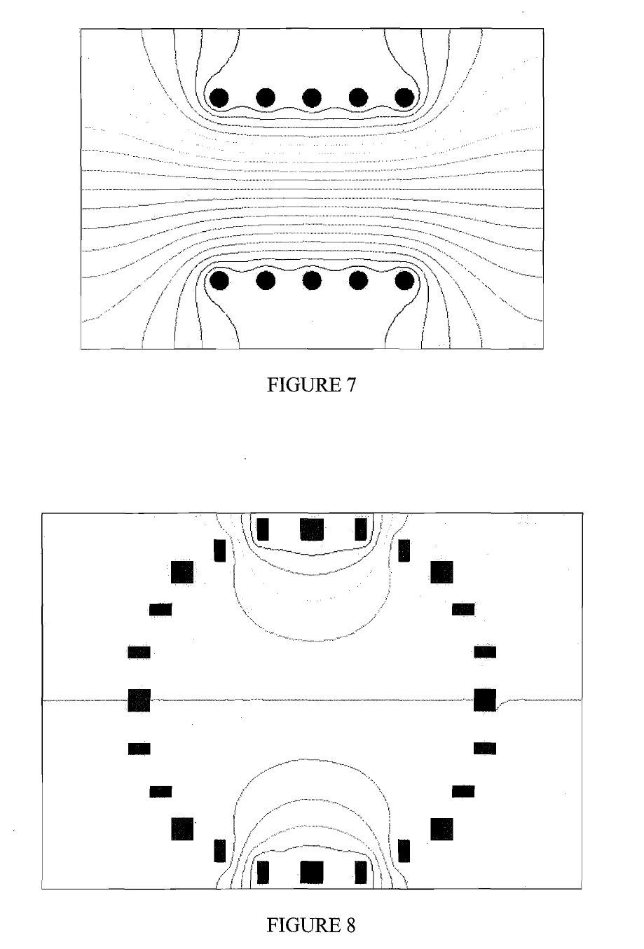

The problem of field distortion can be illustrated in a simulation of a parallel plate capacitor made from spaced wires, as shown in FIG. 6, in which the distance d between simulated upper and lower plates is less than the spacing s between wire elements, thereby leading to a disfigured field. For comparison, FIG. 7 shows that a uniform field is obtained when the distance of simulated surfaces is much greater than the spacing between elements simulating those surfaces, i.e., d>>s. Therefore, an appropriate balancing of factors for the blade construction of the 3HMS deflectors trades off a larger number of blades with a larger ion radius of the central field of the 3HMS unit. More blades will yield less distortion, but also greater complexity and cost. The optimum number of blades will be determined by a compromise between system cost and desired performance. While a 24-blade example is shown above to demonstrate the concept of approximating the field of a hyperbolic deflector surface, the performance of a 12-blade 8-blade, or possibly even a 4-blade deflector array construction may be entirely adequate.

In a related 3HMS design, described in my co-pending U.S. patent application Ser. No. ______, also incorporated herein by reference, the use of square wave or digital waveforms to drive the deflector electrode elements is proposed. Square waves are much easier to produce than sine waves when the frequency has to be swept over a broad range, as in the 3HMS unit. There is also a corresponding decrease in circuit cost. The use of the blade array construction for the deflector electrodes permits a square wave or incrementally rotated drive waveform. By having a 24-blade construction, the field can be stepped in 1 5-degree increments. The result is a parabolic piecewise approximation of a helical ion trajectory. The greater the number of blades, the more perfect this approximation is.

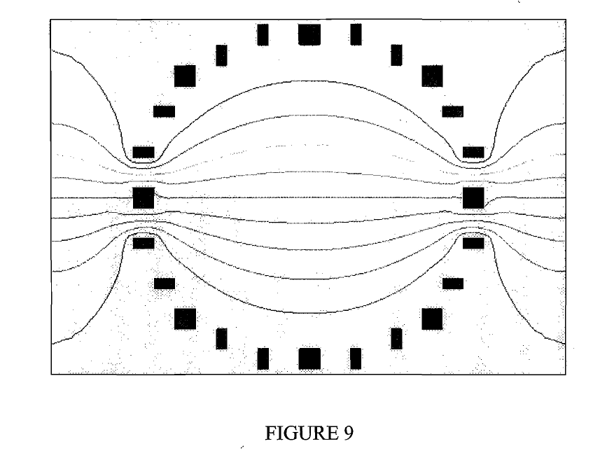

The use of an array of many blade elements also allows the unusual ability to select a particular field shape. Depending on how many blades are charged in parallel, the field shape can change from convex to concave. For example, FIG. 8 shows a 24-blade deflector array generating a convex field shape, while FIG. 9 shows a 24-blade deflector array generating a concave field shape. Ideally, perfect linearity is desirable, but it may be found that the concave field has the additional characteristic of providing a better solution.

The field resolution of a 3HMS unit using the blade array construction for the deflector electrodes is thus determined by a number of desired factors: focusing ability, mechanical and electrical precision, and approximation accuracy of field rotation. The latter factor particularly is eliminated through the use of a sufficient number of blades.

The 3HMS electric field must be swept over a frequency range to produce a spectrum. The amplifiers that produce the voltage drive to the deflection grids must be capable of driving the load. In this application, the loading is purely capacitive, with power dissipation defined by
P=C·f·V²
where C is capacitance, f is frequency, and V is the drive voltage. Reducing the capacitive load is essential in reducing amplifier power output and maximizing performance. The capacitance of each deflection grid is relative to other grids and the outer grounded vacuum housing. A simple parallel plate approximation is given by

$$C = \frac{ɛ \cdot A}{d} .$$

Capacitance is proportional to surface area A and inversely proportional to distance d. The hyberbolic wall surface electrode construction shown in FIG. 2 positions electrodes extremely close to each other with large surface areas, thus resulting in a very large parallel plate capacitance. In contrast, the blade array construction is inherently far superior in this respect. Since the blades are thin, they maintain a good distance from adjacent blades, except near the exit aperture. If the blade profile is kept small, this capacitance is reduced even more. Most significantly, is the virtual elimination of capacitance to the vacuum housing, as the blade surfaces are orthogonal.

Mass spectrometers require a good vacuum to operate in. The hyberbolic wall surface electrode construction is severely enclosed with very little room for molecules to escape. Hence, there will be a slight pressure buildup within the 3HMS unit. In contrast, the skeletal structure of the blade array construction is greatly preferred, as molecules are not trapped and can be easily whisked away.

In summary, the novel blade array construction for the deflection electrodes used in a 3HMS unit can provide the required electric field for the unit, while greatly lowering fabrication costs, allowing easier methods of electrical drive, lowering capacitance, and improving the vacuum environment. In short, cost is greatly reduced and performance increased.

It is understood that many modifications and variations may be devised given the above description of the principles of the invention. It is intended that all such modifications and variations be considered as within the spirit and scope of this invention, as defined in the following claims.

1. A rotating electric field ion mass spectrometer having a three-dimensional construction with an ion axis extending in a longitudinal direction and deflection electrodes forming a three-dimensional rotating electric field extending longitudinally along the ion axis, wherein the deflector electrodes are formed as an array of multiple blade elements arrayed radially and circumferentially about the ion axis and extending longitudinally along the ion axis.

2. A rotating electric field ion mass spectrometer according to claim 1, formed as a hyperbolic helical horn mass spectrometer of the type having deflector electrodes in a horn shape extending in a longitudinal direction along the ion axis, wherein the blade elements are formed as thin, flat metal pieces each having an inner edge shaped in a hyperbolic curve extending along the ion axis, and the blade elements are aligned in orthogonal fashion with respect to each other to approximate hyperbolic wall surfaces for the deflector electrodes of the mass spectrometer.

3. A rotating electric field ion mass spectrometer according to claim 2, wherein the blade elements are selected in a number sufficient to approximate an electric field generated by hyperbolic wall surfaces for the deflector electrodes of the mass spectrometer.

4. A rotating electric field ion mass spectrometer according to claim 3, having an arrangement of 24 blade elements to closely approximate an electric field generated by hyperbolic wall surfaces for the deflector electrodes of the mass spectrometer.

5. A rotating electric field ion mass spectrometer according to claim 1, wherein the blade elements are driven by square wave or digital waveforms.

6. A hyperbolic helical horn mass spectrometer of the type having deflector electrodes in a horn shape extending in a longitudinal direction along an ion axis, wherein the deflector electrodes are formed as an array of multiple blade elements arrayed radially and circumferentially about the ion axis and extending longitudinally along the ion axis.

7. A hyperbolic helical horn mass spectrometer according to claim 6, wherein the blade elements are formed as flat metal pieces each having an inner edge shaped in a hyperbolic curve extending along the ion axis, and the blade elements are aligned in orthogonal fashion with respect to each other to approximate hyperbolic wall surfaces for the deflector electrodes of the mass spectrometer.

8. A hyperbolic helical horn mass spectrometer according to claim 7, wherein each blade element is stamped or cut from a metal sheet.

9. A hyperbolic helical horn mass spectrometer according to claim 6, wherein the blade elements are selected in a number sufficient to approximate an electric field generated by hyperbolic wall surfaces for the deflector electrodes of the mass spectrometer.

10. A hyperbolic helical horn mass spectrometer according to claim 9, having an arrangement of 24 blade elements to closely approximate an electric field generated by hyperbolic wall surfaces for the deflector electrodes of the mass spectrometer.

11. A deflection electrode construction for use in a rotating electric field ion mass spectrometer of the type extending in a longitudinal direction along an ion axis, comprising a deflection electrode formed as flat, metal blade element having an inner edge shaped in a hyperbolic curve extending in a longitudinal direction which is to be aligned with the ion axis of a mass spectrometer.

12. A deflection electrode construction according to claim 11, further comprising an array of multiple blade elements to be arrayed radially and circumferentially about the ion axis and extending longitudinally along the ion axis of a mass spectrometer.

13. A deflection electrode construction according to claim 11, wherein each blade element is stamped or cut from a metal sheet.

14. A deflection electrode construction according to claim 12, wherein the number of blade elements is sufficient to approximate hyperbolic wall surfaces for deflector electrodes of a mass spectrometer.

15. A deflection electrode construction according to claim 14, having an arrangement of 24 blade elements to closely approximate hyperbolic wall surfaces for deflector electrodes of a mass spectrometer.
